(19) United States
(12) Patent Application Publication
(10) Pub. No.: US 2006/0153127 A1
(43) Pub. Date: Jul. 13, 2006

(54) METHOD AND SYSTEM OF BANDWIDTH MANAGEMENT

(75) Inventor: Ming-Tang Lee, Chupei City (TW)

Correspondence Address: CONNOLLY BOVE LODGE & HUTZ LLP, SUITE 800, 1990 M STREET NW, WASHINGTON, DC, 20036-3425, US

(73) Assignee: NETKLASS TECHNOLOGY INC., Chupei City (TW)

(21) Appl. No.: 11/160,933

(22) Filed: Jul. 15, 2005

(30) Foreign Application Priority Data
Jan. 7, 2005 (TW) 094100456

(51) Int. Cl. H04Q 7/00

(52) U.S. Cl. 370/329

(57) ABSTRACT

The present invention discloses a method of bandwidth management, which is used in network transmission, including two main steps of setting a user-level bandwidth and setting an application-level bandwidth. At the first step of setting a user-level bandwidth, firstly, the method provides a IP address for the master user, and secondly, provides at least one IP address for the at least one slave user, and then assigns a primary bandwidth to the IP address for the master user and at least one secondary bandwidth to at least one slave user's IP address accordingly. At the second step of setting an application-level bandwidth, the method executes at least one Internet application, and assigns at least one application bandwidth to at least one Internet application accordingly. At least one Internet application is provided. The setting and assignment of the primary bandwidth and the secondary bandwidth mentioned above could be performed in Graphics Interface, which is friendly to users. The present invention also discloses a system of bandwidth management, which is used in network transmission, including a master unit; at least one slave unit; a network transmission device and a bandwidth management device.

### BACKGROUND OF THE INVENTION

1. Field of the Invention

The present invention relates to a method and a system of bandwidth management for network transmission, more particularly to a method and a system based on a two-level management structure to achieve the bandwidth setting. The method and the system could be operated by a Graphics Interface with convenience.

2. Description of the Related Art

The data transmission in a network is delivered in the form of a packet, and various information packets are struggling for a limited network bandwidth. When the network bandwidth is sufficient to allow the flow of information packets, the data transmission in the network is not influenced. If the network bandwidth is overloaded with a total flow of information packets, blocking of data transmission occurs. For example, when many different kinds of vehicles struggle to change lanes, this will result in a heavy traffic jam, but if each kind of vehicle follows an individual lane, even if a traffic jam occurs in a motorcycle lane, cars and buses in their own lanes may keep going. The concept of bandwidth management is similar to that of the example above. That is, when the data transmission in a network is heavy, or will be blocked, a portion of the network bandwidth would be reserved for the important Internet applications.

With the popularity of the Internet, not only does the requirement of the network transmission from the interior of the enterprise increase, but also the access to the Internet of general families and SOHO users builds up the load on the Internet traffic. The network bandwidth is limited and expensive, and it is impossible to increase the network bandwidth infinitely upon the users' request. To solve this problem, distributing the limited network bandwidth effectively and efficiently to users by using a technology of bandwidth management is one of the solutions. So far, the products of bandwidth management provided by vendors usually cost from NT$ 100,000 to NT$ 1,000,000 or above, and users who understand networks very well must set up and operate the products correctly. For the enterprise-level routers configured with bandwidth management, users have to set some related parameters before operating the routers. These related parameters include class name, bandwidth budget and priority in the field of class configuration; destination IP addresses, destination subnet mask, destination port, source IP address, source subnet mask, source port and protocol ID in the field of filter configuration. The method of setting parameters is achieved by web user interface or telnet. The method of setting parameters is easy and effortless for IT persons in an enterprise, but it is tough and time-consuming for general families and SOHO users.

When setting bandwidth, a one-level management structure is adopted by a general router configured with bandwidth management. That is, the setting and assigning of some user, some Internet application and some bandwidth is completed at one time. If another user, another Internet application and another bandwidth need assigning and setting, the same step is repeated. If we want to assign the priority and the bandwidth to users and distribute the application bandwidth to Internet applications of users, the one-level management structure is obviously inefficient.

In addition, if general families and SOHO users have bought the products without bandwidth management, but they do need the function of bandwidth management at present, it is not easy to find a bandwidth management product with simple operation at a fair expense in the current market.

### SUMMARY OF THE INVENTION

The primary objective of the present invention is to provide a method of bandwidth management, which is used in network transmission, based on a two-level management structure and a Graphics Interface, allowing general families and SOHO users to set the bandwidth. The aforementioned method could be performed by a system of bandwidth management, which is used in network transmission. The system could provide the function of bandwidth management to the general families and SOHO users whose original network configurations do not have the ability of bandwidth management.

In order to achieve the objective, the present invention discloses a method of bandwidth management, which includes two steps of setting a user-level bandwidth and setting an application-level bandwidth. The first step of setting a user-level bandwidth comprises steps (a) to (d). Step (a) provides a IP address for the master user; Step (b) provides at least one IP address for the at least one slave user; Step (c) assigns a primary bandwidth to the IP address for the master user; and Step (d) assigns at least one secondary bandwidth to at least one IP address for the at least one slave user. The second step of setting an application-level bandwidth comprises steps (e) to (h). Step (e) provides a database; Step (f) provides at least one Internet application from the database; Step (g) executes at least one Internet application; and step (h) assigns at least one application bandwidth to at least one Internet application accordingly.

The aforementioned assigning of primary bandwidth, secondary bandwidth and application bandwidth is performed by user-friendly Graphics Interfaces. Adjusting icons and sliders in Graphics Interfaces makes the bandwidth setting easy and convenient for general persons.

The secondary objective of the present invention is to disclose a system of bandwidth management, which is used in network transmission. The system includes a master unit, at least one slave unit and a network transmission device. The master unit and at least one slave unit correspond to an IP address for the master user and at least one IP address for the at least one slave user, respectively, and are used by a master user and at least one slave user, respectively. The network transmission device executes a bandwidth management program to perform the setting of a user-level and an application-level bandwidth. The master unit and at least one slave are connected to the Internet through the network transmission device.

For example, in the system of bandwidth management, if the master unit and the slave units are personal computers, and the network transmission device is a wireless or wired router, then the router is built in with the bandwidth management program to perform the setting of a user-level and an application-level bandwidth. Therefore, new buyers could purchase the router built in with the bandwidth management program. Additionally, if a user has had a router without function of bandwidth management, he/she could only purchase a bandwidth management device, which is connected to the original router, to upgrade his/her local network to equip it with the ability of bandwidth management at less cost.

### BRIEF DESCRIPTION OF THE DRAWINGS

The invention will be described according to the appended drawings in which:

illustrates the first embodiment of the system of bandwidth management of the present invention;

is a flowchart of an embodiment of the method of bandwidth management of the present invention;

is a flowchart of another embodiment of the method of bandwidth management of the present invention;

and 5 illustrate the setting screens of the method of bandwidth management of the present invention; and

and 7 illustrate the second and the third embodiments of the system of bandwidth management of the present invention.

### PREFERRED EMBODIMENT OF THE PRESENT INVENTION

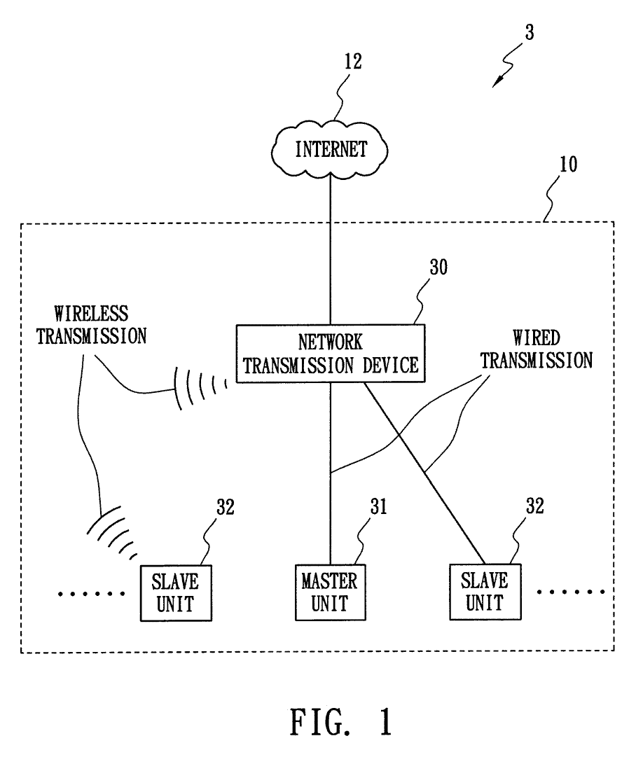

FIG. 1 illustrates the first embodiment of the system of bandwidth management 3 of the present invention, in which a master unit 31 and at least one slave unit 32 are connected to the Internet 12 through a network transmission device 30. The master unit 31, at least one slave unit 32 and the network transmission device 30 form an internal network 10. The network transmission device could be a router, a gateway or an Access Point. The master unit 31 and at least one slave unit 32 could be personal computers, personal digital assistants, mobile phones or devices, which need an IP, address to connect to the Internet 12. Especially, the master unit 31 and at least one slave unit 32 are the computers used by a boss and employee, respectively, in a company, or the computers used by parents and children, respectively, at home. In general, the boss and the parents deal with more important things, and they need more bandwidth.

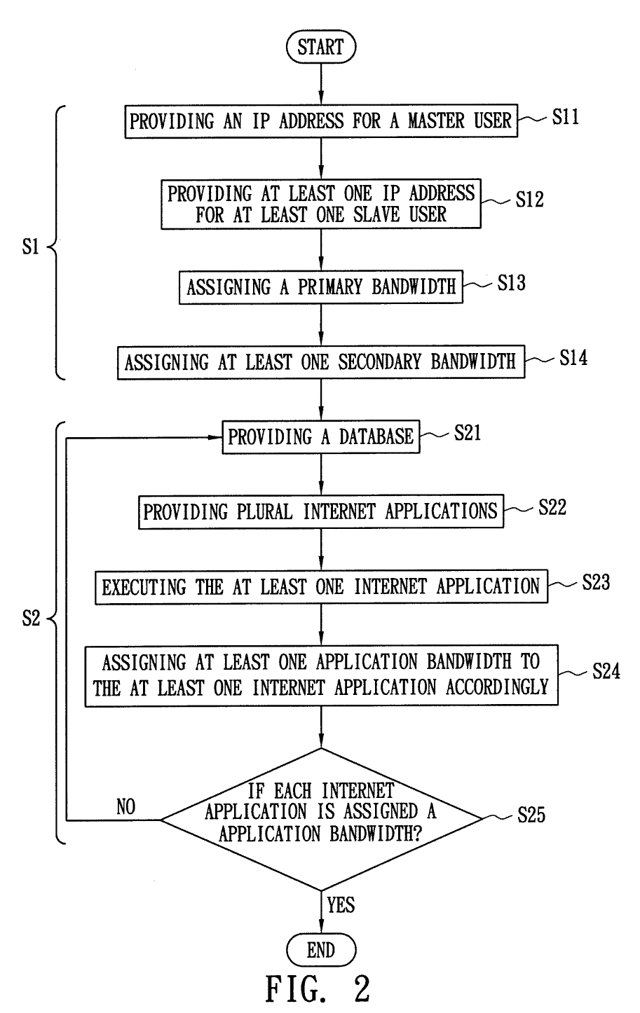

FIG. 2 is the flowchart of an embodiment of the method of bandwidth management, which contains the first main step, assigning a user-level bandwidth S1, and the second main step, assigning an application-level bandwidth S2. A user logs in a network unit in the internal network 10 at home or in the SOHO environment with a password to obtain identification as a master user, and then the said network unit is called a master unit 31. Other users using the other network units are called slave users, and the other network units are called slave units 32. The master user could use the master unit 31 to assign a primary bandwidth to the master unit 31 and assign at least one secondary bandwidth to at least one slave unit 32 through the internal network 10.

The first main step of assigning a user-level bandwidth S1 includes the following steps. The network transmission device 30 provides an IP address for the master user (S11) and provides at least one IP address for the at least one slave user (S12). The IP address for the master user and at least one slave user's IP address correspond to the master unit 31 and the slave unit 32, respectively. Then, the master user assigns a primary bandwidth, through the network transmission device 30, to the IP address for the master user (S13) used for the master unit 31. After that, the master user assigns at least one secondary bandwidth, through the network transmission device 30, to at least one slave user's IP address accordingly (S14).

The second main step of assigning an application-level bandwidth S2, which is applied to each user including the master user and the slave users, comprises the following steps. At first, a database is provided (S21), which is built in the network transmission device 30. The database stores plural Internet applications executed recently in the master unit 31 and at least one slave unit 32, and thus the database is updated regularly. The aforementioned Internet applications are those that occupy the network bandwidth when executed. Then the database provides the plural Internet applications (S22) as a frequently used program list to each network unit including master unit 31 and slave unit 32. Each network unit receives a program list. After that, each network unit executes at least one of the plural Internet applications (S23) or other Internet applications which are not in its program list. Then, the master user assigns at least one application bandwidth to at least one Internet application accordingly (S24), in which at least one Internet application runs in each network unit. The total of application bandwidths occupied by the Internet applications run in the master unit 31 is not larger than the minimum of the primary bandwidth. Similarly, the total of application bandwidths occupied by the Internet applications run in each slave unit 32 is not larger than the minimum of the corresponding secondary bandwidth.

For easy and convenient use, the application bandwidth is graded with three levels; for example, best, better and normal. Afterward, the network transmission device 20 checks if each Internet application is assigned an application bandwidth (S25). If each Internet application is assigned, then the second main step ends, or continues to S21. In addition, the master user could use the master unit 31 through the internal network 10 to control the connection status of the slave user's IP address; that is, to halt or connect the slave user's IP address to the Internet 12.

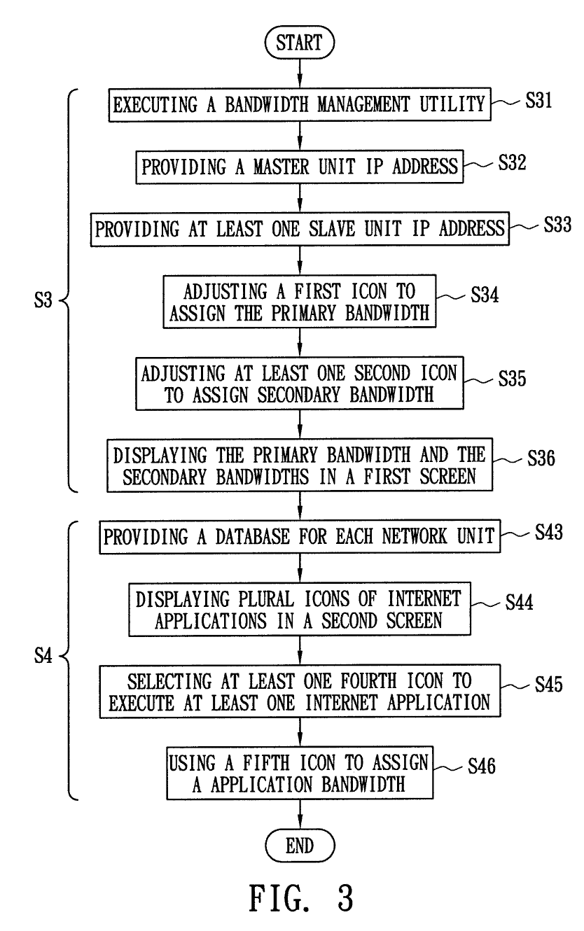

The method of bandwidth management above could use the Graphics Interfaces to set or assign bandwidths, whose flowchart is shown in FIG. 3, in which the step of setting a user-level bandwidth S3 includes steps from S31 to S36, and the step of setting an application-level bandwidth S4 includes steps from S43 to S46. The master unit 31 has the authority to set bandwidths to the master unit 31 and slave units 32 in the internal network 10 and executes a bandwidth management utility (S31) to provide a master unit IP address (S32) and at least one slave unit IP address (S33). After that, the master user adjusts a first icon to assign a primary bandwidth to the master unit IP address (S34), and then adjusts at least one second icon to assign at least one secondary bandwidth to the corresponding slave unit IP address (S35). The utility displays the primary bandwidth and the secondary bandwidth in a first screen (S36).

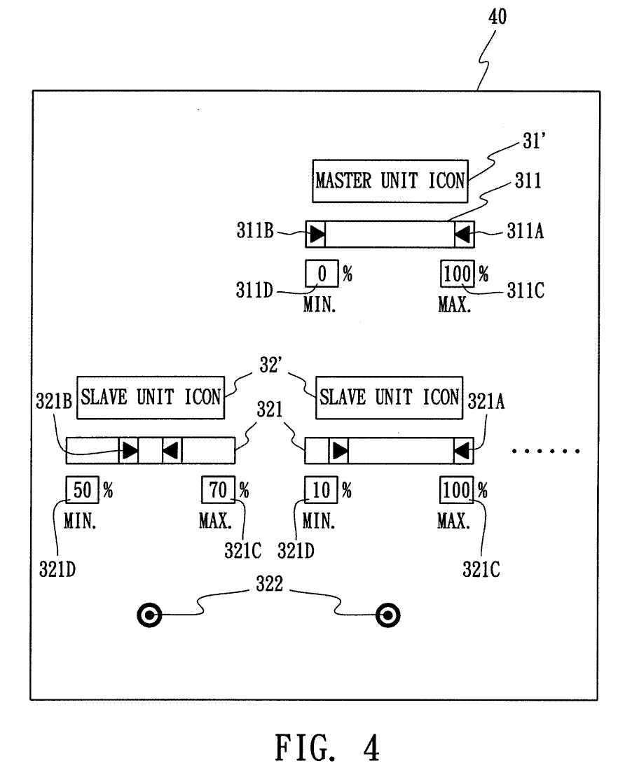

FIG. 4 illustrates an arrangement of icons for setting the bandwidth in a first screen 40. The first screen 40 displays a master unit icon 31′ and at least one slave unit icon 32′, which means these units are connected to the Internet 12 currently. A first icon 311, a rectangular icon with two triangle sliders 311A and 311B at both ends, is shown below the master unit icon 31′, to adjust the maximum and minimum of the primary bandwidth set for the master unit. The master user could click and drag the slider 311A to adjust the maximal primary bandwidth (or primary bandwidth limitation), the value in the MAX. window 311C. Also, the master user could click and drag the slider 311B to adjust the minimal primary bandwidth (or guaranteed primary bandwidth), the value in the MIN. window 311D. At S34 step, the maximum and minimum of primary bandwidth are displayed in MAX. window 311C and MIN. windows 311D, respectively, and in the form of a percentage.

Similarly, the second icon 321 and sliders 321A, 321B are used to adjust the secondary bandwidth of the corresponding slave unit 32. The maximal secondary bandwidth (or secondary bandwidth limitation) and the minimal secondary bandwidth (or guaranteed secondary bandwidth) are shown in MAX. window 321C and MIN. window 321D, respectively, and in the form of a percentage. In addition, there is a third icon 322 for each slave unit icon 32′, which is used to control the connection status of the slave unit 32; that is, the user clicks the third icon 322 to halt the connection to the Internet 12; the user clicks the third icon 322 again to restore the connection to the Internet 12.

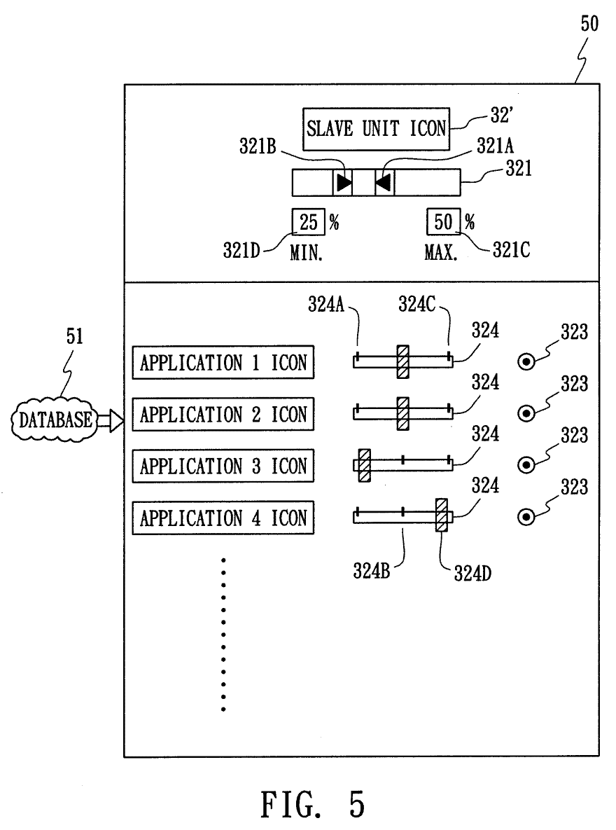

Setting an application-level bandwidth includes the following steps. Firstly, the utility provides a database for each network unit (S43) including master unit 31 and slave unit 32. A network unit has a corresponding database. All the databases are stored in the network transmission device 30, and each database records a list of the Internet applications executed recently in the corresponding network unit, and thus the list changes accordingly. Secondly, plural icons of the Internet applications executed in a network unit are displayed in a second screen 50 (shown in FIG. 5) (S44), and the master user clicks at least one fourth icon 323 to execute at least one corresponding Internet application (S45). In this embodiment, a fourth icon 323 acts as a network connection button; that is, the master user clicks a fourth icon 323 to halt the network connection of the corresponding Internet application, and clicks again to restore the connection. Then, the utility uses a fifth icon 324 to adjust an application bandwidth (S46).

In FIG. 4, the master user could click the master unit icon 31′ or the slave unit icon 32′ to enter a second screen 50 (shown in FIG. 5) of a corresponding network unit. FIG. 5 illustrates an arrangement of icons for setting the application bandwidths. Plural application icons displayed in the lower half screen are provided by a database 51 and executing in the slave unit 32. For each application icon, a fifth icon 324, with three available positions of 324A, 324B and 324C, is displayed on its right. The three available positions 324A, 324B and 324C represent three preset levels of application bandwidths; for example, best, better and normal. The master user clicks and drags a slider 324D to one of the three available positions 324A, 324B and 324C to assign application bandwidth for each Internet application. In the second screen 50, plural fourth icons 323 are provided to control the status of connections of each Internet application, whose functions are like the third icons 322.

Using the Graphics Interfaces of the two-level management structure provided by the first screen 40 and the second screen 50 makes the bandwidth management, which was originally difficult and time-consuming, easier and more friendly.

To avoid performing the method of bandwidth management after each connection to the Internet 12, the primary bandwidth, the secondary bandwidths and the corresponding IP addresses could be stored in the network transmission device 30 as a set of default parameters after steps from S31 to S36 are completed to allow the set of default parameters to be downloaded directly to network units for the next connection to the Internet 12. The aforementioned procedure of downloading the contents of the set of default parameters and then distributing the bandwidths to the corresponding IP addresses is called a bandwidth setting procedure. Another embodiment of the bandwidth setting procedure is described as follows: after steps S31, S32 and S33 are completed, the bandwidth (that is, the sum of the primary bandwidth and the at least one secondary bandwidth) provided by an Internet Service provider (ISP) is distributed equally to the IP address for the master user and the slave users' IP addresses. For accessing this default more conveniently, the network transmission device 30 further includes a trigger to execute the bandwidth setting procedure. The trigger could be a button or a switch. Once the trigger is activated, the master user could use this default to complete the setting of bandwidths.

The method of bandwidth management above could be controlled by software or a firmware built in the transmission device 30 (for example, a router). Additionally, if a user has had a transmission device without bandwidth management capability, the user could purchase a bandwidth management device configured with the method of the present invention. The details of the bandwidth management device are described as follows.

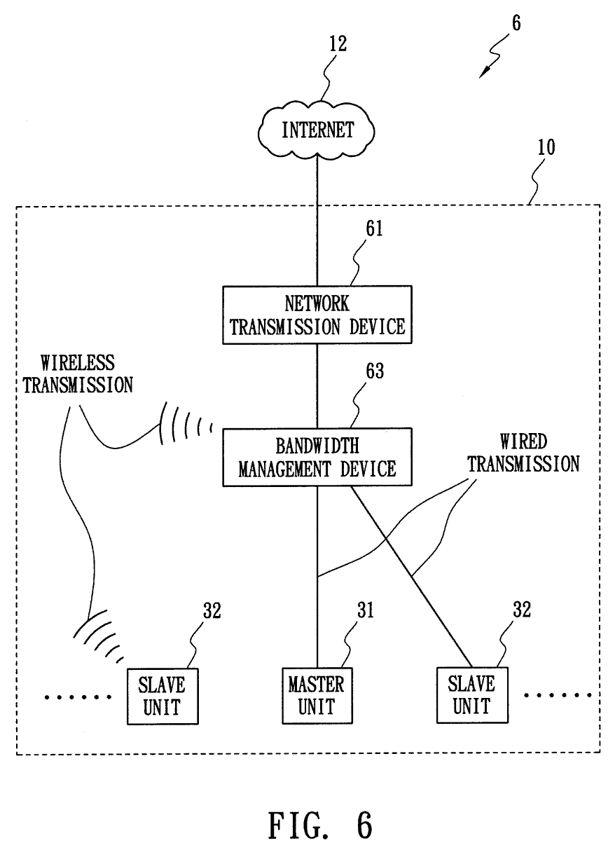

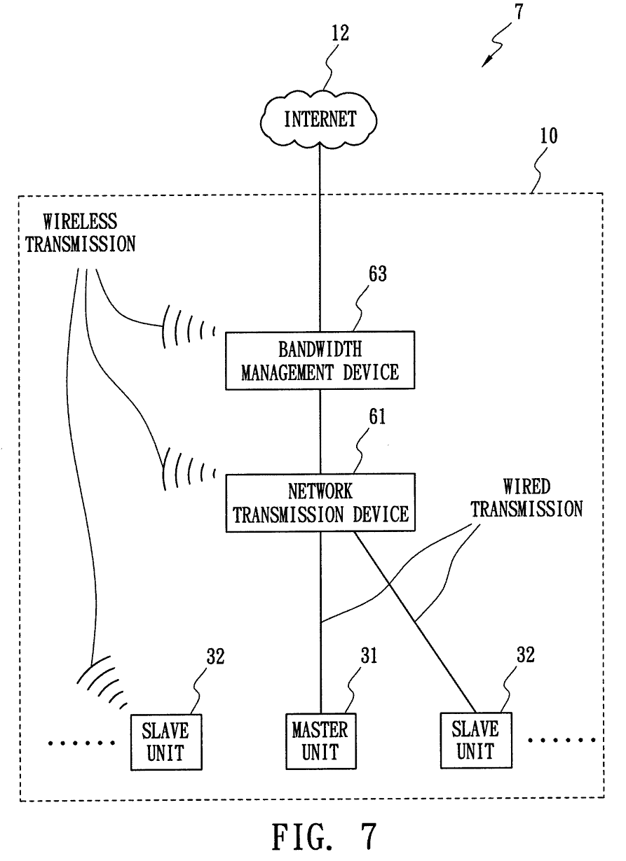

FIGS. 6 and 7 are two embodiments of the system of bandwidth management of the present invention. Compared with FIG. 1, the network transmission device 30 is replaced with a network transmission device 61 and a bandwidth management device 63, wherein the network transmission device 61 connects to the bandwidth management device 63 in series. The network transmission device 61, such as a traditional router or gateway, cannot perform the method of the present invention. After combining the bandwidth management device 63 configured with software of a firmware, which can perform the method of the present invention, and the network transmission device 61, the result would be an upgrade with the ability of bandwidth management.”

The connections between the network transmission device 61 and the bandwidth management device 63 in FIG. 6 and FIG. 7 are different in order. The network transmission device 61 is connected directly to the Internet 12 in the former, and the bandwidth management device 63 is connected to the Internet 12 in the latter. Both of them could perform the method of bandwidth management.

In addition, the bandwidth management device 63 contains a trigger to perform a bandwidth setting procedure. The trigger could be a button or a switch.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed as new and desired to be protected by Letters Patent of the United States is:

1. A method of bandwidth management, which is utilized in network transmission, comprising the steps of:
setting a user-level bandwidth; and
setting an application-level bandwidth.

2. The method of bandwidth management of claim 1, further comprising the step of logging in with a password to obtain the authority of a master user.

3. The method of bandwidth management of claim 1, wherein the step of setting the user-level bandwidth comprises:
providing an IP address for the master user;
providing at least one IP address for at least one slave user;
assigning a primary bandwidth to the IP address for the master user; and
assigning at least one secondary bandwidth to the at least one IP address for at least one slave user.

4. The method of bandwidth management of claim 3, wherein the primary bandwidth is assigned by an icon in a Graphics Interface.

5. The method of bandwidth management of claim 3, wherein the secondary bandwidth is assigned by icons in a Graphics Interface.

6. The method of bandwidth management of claim 3, wherein the primary bandwidth and the secondary bandwidths are presented in a percentage.

7. The method of bandwidth management of claim 3, wherein the step of setting the user-level bandwidth further includes the step of controlling the connection status of the at least one slave user's IP address.

8. The method of bandwidth management of claim 7, wherein the connection status is controlled by icons in a Graphics Interface.

9. The method of bandwidth management of claim 3, which is operated with a bandwidth management device, a master unit and at least one slave unit, wherein the master unit and the at least one slave unit correspond to the IP address for the master user and the at least one slave user's IP address respectively, and the bandwidth management device is used to set the user-level bandwidth and to set the application-level bandwidth.

10. The method of bandwidth management of claim 9, wherein the master unit and the at least one slave unit are connected to the Internet through the bandwidth management device.

11. The method of bandwidth management of claim 9, wherein the bandwidth management device is a router, a gateway or an Access Point.

12. The method of bandwidth management of claim 9, wherein the master unit and the at least one slave unit are selected from the group of computers, personal digital assistants, mobile phones or Internet connection devices using IP address.

13. The method of bandwidth management of claim 1, wherein the step of setting the application-level bandwidth comprises:
executing at least one Internet application; and
assigning at least one application bandwidth to the at least one Internet application.

14. The method of bandwidth management of claim 13, wherein the at least one Internet application is provided by a database.

15. The method of bandwidth management of claim 13, wherein the at least one Internet application is executed by icons in a Graphics Interface.

16. The method of bandwidth management of claim 13, wherein the at least one application bandwidth is assigned by icons in a Graphics Interface.

17. The method of bandwidth management of claim 13, wherein the at least one application bandwidth is graded.

18. The method of bandwidth management of claim 14, wherein the at least one Internet application is updated regularly.

19. The method of bandwidth management of claim 3, wherein the step of setting the application-level bandwidth includes:
executing at least one Internet application; and
assigning at least one application bandwidth to the at least one Internet application and the at least one application bandwidth is less than or equal to the at least one secondary bandwidth.

20. The method of bandwidth management of claim 9, wherein the bandwidth management device includes a trigger for executing a bandwidth setting procedure.

21. The method of bandwidth management of claim 20, wherein the trigger is a button or a switch.

22. The method of bandwidth management of claim 20, wherein the bandwidth setting procedure includes the steps of:
downloading the primary bandwidth, the at least one secondary bandwidth and the IP addresses; and
distributing the primary bandwidth and the at least one secondary bandwidth to the IP addresses.

23. The method of bandwidth management of claim 22, wherein the primary bandwidth and the at least one secondary bandwidth are distributed equally to the IP addresses.

24. A system of bandwidth management, which is utilized in network transmission, comprising:
a master unit, which is used by a master user;
at least one slave unit, which is used by at least one slave user; and
a network transmission device, which executes a bandwidth management program to set a user-level bandwidth and an application-level bandwidth;
wherein the master unit and the at least one slave unit are connected to the Internet through the network transmission device.

25. The system of bandwidth management of claim 24, wherein the user-level bandwidth is set by the steps comprising:
providing an IP address for the master user;
providing at least one IP address for the at least one slave user;
assigning a primary bandwidth to the IP address for the master user;
assigning at least one secondary bandwidth to the at least one IP address for the at least one slave user.

26. The system of bandwidth management of claim 24, wherein the application-level bandwidth is set by the steps comprising:
executing at least one Internet application; and
assigning at least one application bandwidth to the at least one Internet application.

27. The system of bandwidth management of claim 24, wherein the network transmission device is a router, a gateway or an Access Point.

28. The system of bandwidth management of claim 24, wherein the network transmission device includes a trigger for executing a bandwidth setting procedure.

29. The system of bandwidth management of claim 28, wherein the trigger is a button or a switch.

30. The system of bandwidth management of claim 28, wherein the bandwidth setting procedure includes the steps of:
providing an IP address for the master user;
providing at least one IP address for the at least one slave user; and
distributing a bandwidth to IP addresses for the master user and the at least one slave user.

31. The system of bandwidth management of claim 30, wherein the bandwidth is distributed equally to the IP addresses for the master user and the at least one slave user.

32. A system of bandwidth management, which is utilized in network transmission, comprising:
a master unit, which is used by a master user;
at least one slave unit, which is used by at least one slave user; and
a network transmission device, which transmits data from the master unit and at least one slave unit to the Internet; and
a bandwidth management device, which is connected in series to the network transmission device and sets a user-level bandwidth and an application-level bandwidth.

33. The system of bandwidth management of claim 32, wherein the user-level bandwidth is set by the steps comprising:
providing an IP address for the master user;
providing at least one IP address for the slave user;
assigning a primary bandwidth to the IP address for the master use;
assigning at least one secondary bandwidth to the at least one IP address for the slave user.

34. The system of bandwidth management of claim 32, wherein the application-level bandwidth is set by the steps comprising:
executing at least one Internet application; and
assigning at least one application bandwidth to at least one Internet application.

35. The system of bandwidth management of claim 32, wherein the bandwidth management device includes a trigger executing a bandwidth setting procedure.

36. The system of bandwidth management of claim 35, wherein the trigger is a button or a switch.

37. The system of bandwidth management of claim 35, wherein the bandwidth setting procedure includes the steps of:
providing an IP address for the master user;
providing at least one IP address for the slave user; and
distributing a bandwidth to the IP addresses for the master user and the at least one slave user.

38. The system of bandwidth management of claim 37, wherein the bandwidth is distributed equally to the IP addresses for the master user and the at least one slave user.
